(19) United States
(12) Patent Application Publication
(10) Pub. No.: US 2025/0149265 A1
(43) Pub. Date: May 8, 2025

(54) METALLIZED FILM MANUFACTURING DEVICE, METALLIZED FILM, AND FILM CAPACITOR

(71) Applicants: SHIZUKI ELECTRIC CO., INC., Nishinomiya-shi (JP); Murata Manufacturing Co., Ltd., Nagaokakyo-shi (JP)

(72) Inventors: Atsushi KAWABATA, Nishinomiya-shi (JP); Tomoki INAKURA, Nagaokakyo-shi (JP); Kouji TAKAGAKI, Nagaokakyo-shi (JP)

(21) Appl. No.: 19/005,773

(22) Filed: Dec. 30, 2024

Related U.S. Application Data
(63) Continuation of application No. PCT/JP2023/023789, filed on Jun. 27, 2023.

(30) Foreign Application Priority Data
Jul. 7, 2022 (JP) 2022-109957

(51) Int. Cl. H01G 13/00; H01G 4/14; H01G 4/32

(52) U.S. Cl. CPC H01G 13/00; H01G 4/145; H01G 4/32

(57) ABSTRACT

A metallized film manufacturing device that includes: a feeding unit that feeds a dielectric film in a longitudinal direction; a printing roll that has a rotation axis along a width direction of the dielectric film, and prints an insulation pattern on a surface of the dielectric film, the printing roll has a protrusion extending on an outer circumferential surface of the printing roll in an axial direction of the printing roll and that corresponds to the insulation pattern, and a reinforcing portion is at a first end of the protrusion, the first end being an end in the axial direction of the printing roll; and a vapor deposition unit that forms a metal vapor deposition electrode in a place on a surface of the dielectric film where the insulation pattern is not printed.

### CROSS REFERENCE TO RELATED APPLICATIONS

The present application is a continuation of International application No. PCT/JP2023/023789, filed Jun. 27, 2023, which claims priority to Japanese Patent Application No. 2022-109957, filed Jul. 7, 2022, the entire contents of each of which are incorporated herein by reference.

### TECHNICAL FIELD

The present disclosure relates to a metallized film manufacturing device, a metallized film, and a film capacitor.

### BACKGROUND ART

A film capacitor formed by laminating or winding a dielectric film having a vapor deposition electrode formed on a surface thereof is known. For example, Patent Document 1 describes a metallized film capacitor in which a first vapor deposition electrode is disposed on one dielectric film and a second vapor deposition electrode is disposed on the other dielectric film.

In the film capacitor of Patent Document 1, the first vapor deposition electrode and the second vapor deposition electrode are each divided by partitioning margins extending in a width direction to have first divided electrodes and second divided electrodes, respectively. Patent Document 1: JP-A-2010-199479

### SUMMARY OF THE DISCLOSURE

The metallized film capacitor described in Patent Document 1 still has room for improvement in terms of suppressing variation in capacitance.

The present disclosure provides a metallized film manufacturing device, a metallized film, and a film capacitor in which variation in capacitance can be suppressed.

A metallized film manufacturing device according to one embodiment of the present disclosure is a metallized film manufacturing device including: a feeding unit that feeds a dielectric film in a longitudinal direction; a printing roll that has a rotation axis along a width direction of the dielectric film, and prints an insulation pattern on a surface of the dielectric film, the printing roll has a protrusion extending on an outer circumferential surface of the printing roll in an axial direction of the printing roll and that corresponds to the insulation pattern, and a reinforcing portion is at a first end of the protrusion, the first end being an end in the axial direction of the printing roll; and a vapor deposition unit that forms a metal vapor deposition electrode in a place on a surface of the dielectric film where the insulation pattern is not printed.

A metallized film according to one embodiment of the present disclosure is a metallized film including a dielectric film, and a metal vapor deposition electrode provided on a surface of the dielectric film with an insulation margin provided at one end portion in a width direction of the dielectric film, wherein the metal vapor deposition electrode includes a plurality of divided electrodes separated by a slit provided along the width direction of the dielectric film, and each of the plurality of divided electrodes has a cutout at a corner opposing the insulation margin.

A film capacitor according to one embodiment of the present disclosure is a film capacitor including the metallized film according to the above-mentioned metallized film and a pair of end surface electrodes disposed at two ends of the metallized film.

According to the present disclosure, a metallized film manufacturing device, a metallized film, and a film capacitor in which variation in capacitance can be suppressed are provided.

### BRIEF DESCRIPTION OF THE DRAWINGS

FIG. 1A is a schematic view showing a metallized film according to a first embodiment of the present disclosure.

FIG. 1B is an enlarged view of a region E1 in FIG. 1A.

FIG. 2 is a schematic view showing a film capacitor according to the first embodiment of the present disclosure.

FIG. 3 is a schematic view showing a pair of metallized films included in a wound body.

FIG. 4 is a schematic view showing a metallized film manufacturing device according to the first embodiment of the present disclosure.

FIG. 5 is a perspective view showing a printing roll of the metallized film manufacturing device in FIG. 4.

FIG. 6A is a view in which protrusions of the printing roll in FIG. 5 are developed in a plane.

FIG. 6B is a view showing an insulation pattern printed by the protrusions of the printing roll.

FIG. 7 is a schematic view showing a step of forming an insulation pattern by the metallized film manufacturing device in FIG. 4.

FIG. 8 is a table showing the relationship among a slit width, a distance between end portions, on an insulation margin side, of adjacent divided electrodes, and occurrence of distortion in the divided electrodes.

FIG. 9 is a schematic view showing a metallized film according to a first exemplary modification of the first embodiment.

FIG. 10 is a schematic view showing a metallized film according to a second exemplary modification of the first embodiment.

FIG. 11 is a schematic view showing a metallized film according to a third exemplary modification of the first embodiment.

### DETAILED DESCRIPTION OF THE PREFERRED EMBODIMENTS

### Circumstances Leading to Present Disclosure

A film capacitor formed by winding or laminating a dielectric film having a vapor deposition electrode provided on a surface thereof is known. In the film capacitor, a pattern margin may be provided on the vapor deposition electrode to improve safety. For example, in the film capacitor described in Patent Document 1, the vapor deposition electrode is divided by a partitioning margin extending in the width direction.

The partitioning margin does not contribute to the capacitance of the film capacitor. Therefore, reducing the width of the partitioning margin is effective in increasing the capacitance of the film capacitor to achieve downsizing and cost reduction of the film capacitor.

To form the partitioning margin, oil is applied to a portion where a pattern of the partitioning margin is formed before metal is vapor-deposited on a dielectric film. For example, a printing roll is used for applying oil, but for a narrow partitioning margin which requires a narrow pattern width for a printing roll, distortion may be created in the printing roll. Distortion created in the printing roll may create distortion in the partitioning margin provided on the dielectric film, resulting in reduction in the area of the vapor deposition electrode to cause a decrease in capacitance of the film capacitor.

The present inventor (inventors) has studied a metallized film manufacturing device, a metallized film, and a film capacitor in which distortion in the partitioning margin is reduced and variation in capacitance can be suppressed.

### First Embodiment

### Overall Configuration

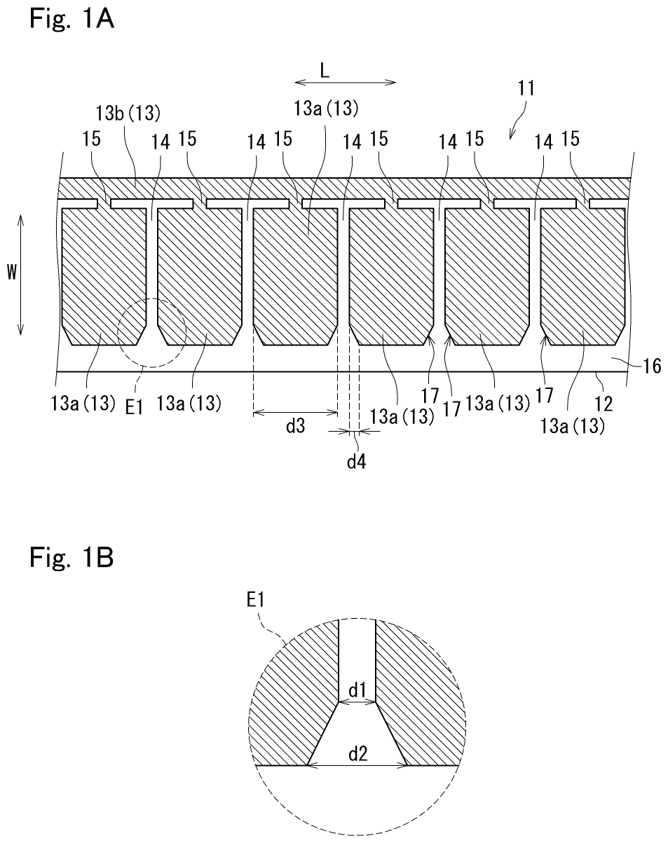

FIG. 1A is a schematic view showing a metallized film 11 according to a first embodiment of the present disclosure. FIG. 1B is an enlarged view of a region E1 in FIG. 1A.

### Metallized Film

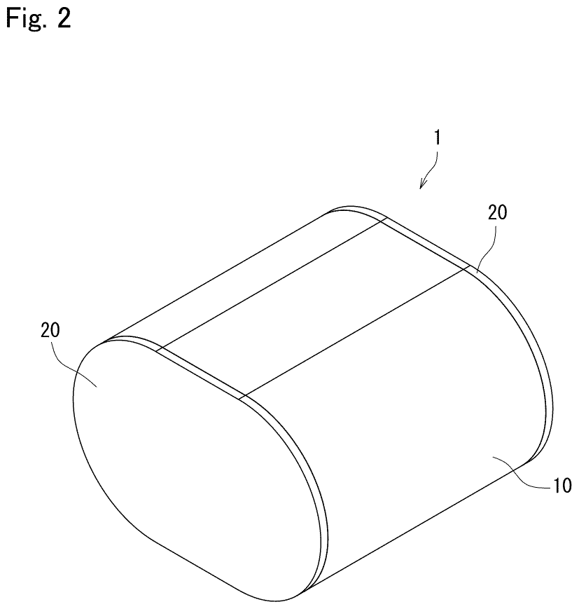

The metallized film 11 is a film in which a metal vapor deposition electrode 13 is provide on a surface of a dielectric film 12. The metallized film 11 is laminated or wound to form a film capacitor 1 illustrated in FIG. 2 to be described later.

The dielectric film 12 is formed of, for example, a plastic film containing a thermoplastic resin such as polyethylene terephthalate, polypropylene, polyphenylene sulfide, and polyethylene naphthalate, or a plastic film containing a thermosetting resin such as a cured product obtained by reaction of a hydroxyl group (OH group) included in a first organic material and an isocyanate group (NCO group) included in a second organic material. The metal vapor deposition electrode 13 is made of metal such as aluminum and zinc, for example.

The metal vapor deposition electrode 13 is divided into a plurality of divided electrodes 13a by a plurality of slits 14 provided along a width direction W of the dielectric film 12. The metal vapor deposition electrode 13 includes, at one end in the width direction W of the dielectric film 12, a connecting portion 13b extending along a longitudinal direction L of the dielectric film 12. Each of a plurality of divided electrodes 13a is connected to the connecting portion 13b via a fuse 15.

At the other end in the width direction W of the dielectric film 12, an insulation margin 16 where no metal vapor deposition electrode is formed is provided along the longitudinal direction L of the dielectric film 12. The insulation margin 16 is connected to each of the slits 14.

Each of a plurality of divided electrodes 13a has a cutout 17 at a corner opposing the insulation margin 16. As illustrated in FIG. 1B, each cutout 17 is provided at an end portion, close to the insulation margin 16, of the slit 14, so as the slit 14 to be wider toward the insulation margin 16. In other words, the slit 14 is provided such that the width of the slit 14 at the end portion, on the insulation margin 16 side, increases from width d1 to width d2 toward the insulation margin 16. In the present embodiment, the cutout 17 is formed in a chamfered shape.

In the present embodiment, slit width d1 of the slit 14 is 0.2 mm or less. The slit 14 is a portion on the dielectric film 12 where no metal vapor deposition electrode 13 is formed, and does not contribute to the capacitance of the film capacitor 1. Therefore, the slit width d1 is desirably small, preferably 0.2 mm or less, to increase the capacitance of the film capacitor 1 as much as possible. The slit width d1 of 0.2 mm or less enables downsizing of the film capacitor 1.

As illustrated in FIG. 1B, the ratio of the second slit width d2 wider than the slit width d1 to the first slit width d1 of the slit 14 is preferably 2 to 42. The second slit width d2 is the distance between the end portions, on the insulation margin 16 side, of the adjacent divided electrodes 13a. In other words, the ratio of the distance d2 between the end portions, on the insulation margin 16 side, of the adjacent divided electrodes 13a to the slit width d1 is preferably 2 to 42. The cutout 17 is provided such that the ratio between the second slit width d2 to the first slit width d1 is 2 to 42. With such the cutout 17 provided, occurrence of distortion in the slit 14 can be suppressed and a decrease in capacitance of the film capacitor 1 can be suppressed.

### Film Capacitor

FIG. 2 is a schematic view showing the film capacitor 1 according to the first embodiment of the present disclosure.

As shown in FIG. 2, the film capacitor 1 includes a wound body 10 formed by winding a pair of laminated metallized films 11, and a pair of end surface electrodes 20 disposed at two ends of the wound body 10.

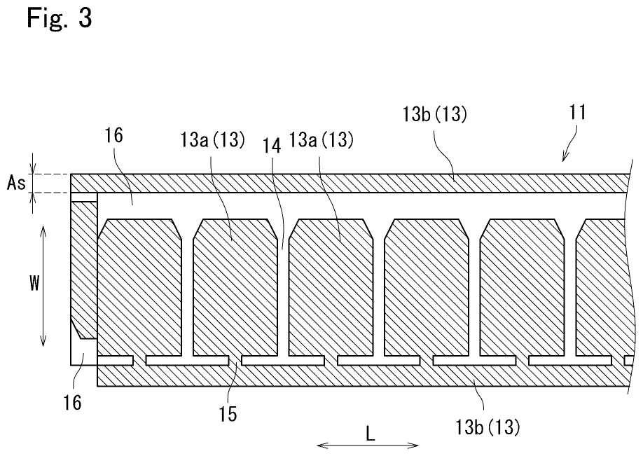

FIG. 3 is a schematic view showing a pair of metallized films 11 included in the wound body 10. The wound body 10 is formed by winding a pair of metallized films 11 laminated in a thickness direction thereof. The wound body 10 may be formed by laminating a plurality of metallized films 11.

As shown in FIG. 3, a pair of metallized films 11 is laminated with a shift by a shift width As in the width direction W of the dielectric film 12. The metallized films 11 are laminated so as the connecting portions 13b of the metallized films 11 to be disposed on opposite sides in the width direction W of the dielectric film 12. After a pair of metallized films 11 is wound, the connecting portion 13b of one of the metallized films 11 is connected to one of a pair of end surface electrodes 20 and the connecting portion 13b of the other metallized film 11 is connected to the other one of a pair of end surface electrodes 20.

Forming the insulation margin 16 at the end portion, opposite to the connecting portion 13b, on the metallized film 11 prevents a short circuit between the connecting portion 13b of the metallized film 11 on one side and the end surface electrode 20 on the other side.

### Metallized Film Manufacturing Device

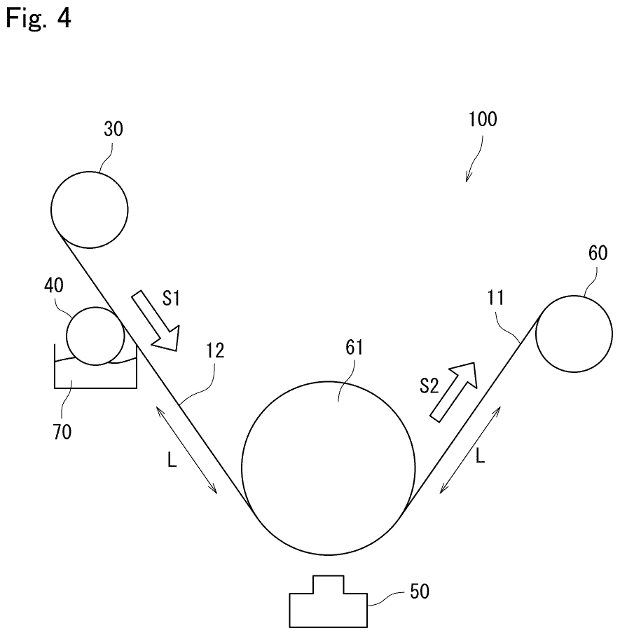

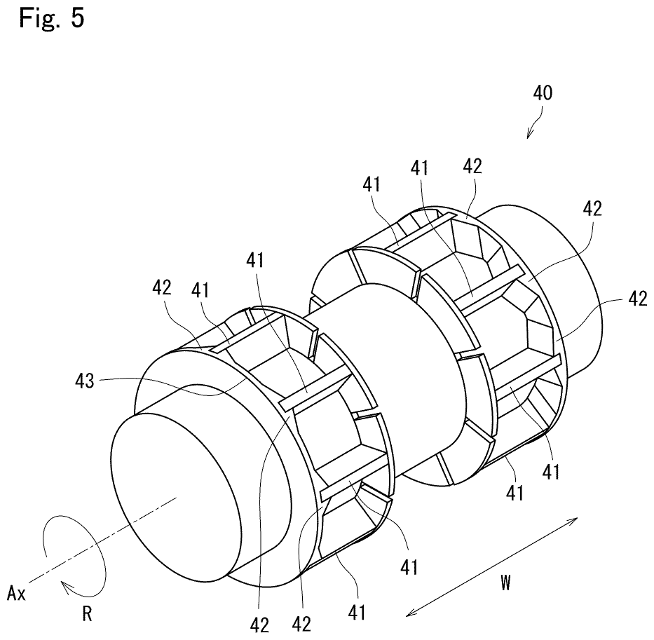

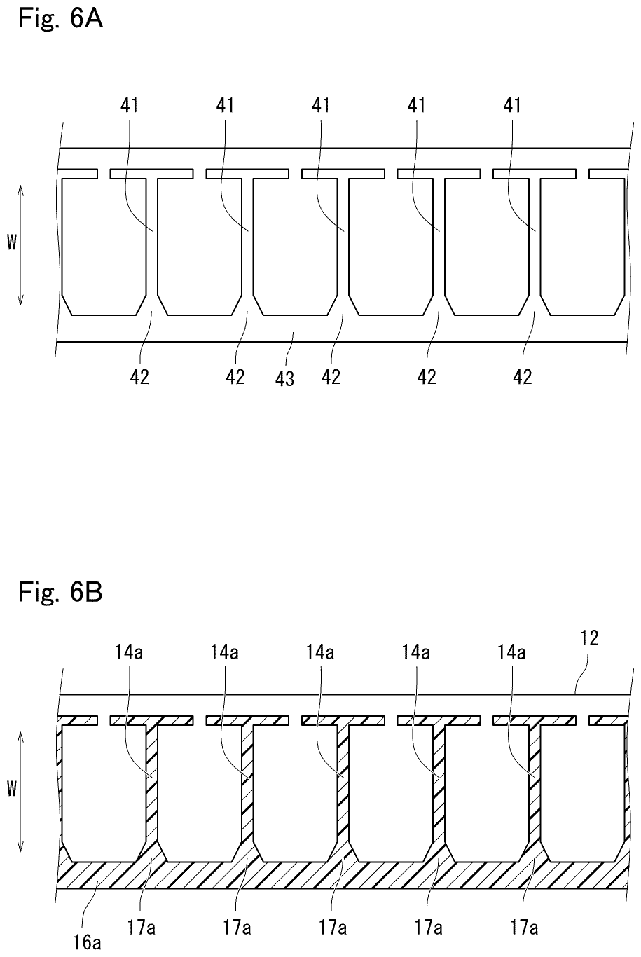

A metallized film manufacturing device 100 will be described with reference to FIGS. 4 to 6B. FIG. 4 is a schematic view showing the metallized film manufacturing device 100 according to the first embodiment of the present disclosure. FIG. 5 is a perspective view showing a printing roll 40 of the metallized film manufacturing device 100 in FIG. 4. FIG. 6A is a view in which protrusions 41 of the printing roll 40 in FIG. 5 are developed on a plane. FIG. 6B is a view showing an insulation pattern printed by the protrusions 41 of the printing roll 40.

The metallized film manufacturing device 100 includes a feeding unit 30, a printing roll 40, and a vapor deposition unit 50. The feeding unit 30 feeds the dielectric film 12 to the metallized film manufacturing device 100. The printing roll 40 applies oil to a surface of the dielectric film 12 for formation of an insulation pattern on which no metal is vapor-deposited. The vapor deposition unit 50 performs vapor deposition of metal on a portion where oil is not applied by the printing roll 40.

In the manufacturing device 100, the dielectric film 12 is fed from the feeding unit 30 in a direction indicated by an arrow S1, that is, the longitudinal direction L of the dielectric film 12, and oil for forming the insulation pattern is applied to the surface of the dielectric film 12 by the printing roll 40. The metal vapor deposition electrode 13 is then formed by the vapor deposition unit 50 on places other than where the insulation pattern is printed on the surface of the dielectric film 12. The metallized film 11 on which the metal vapor deposition electrode 13 is formed is fed in a direction indicated by an arrow S2 and wound by the winding unit 60. An intermediate roller 61 is disposed between the feeding unit 30 and the winding unit 60.

As shown in FIG. 5, the printing roll 40 has a rotation axis Ax extending along the width direction W of the dielectric film 12 fed in the longitudinal direction L. That is, the printing roll 40 has the rotation axis Ax extending in the direction intersecting the direction in which the dielectric film 12 is fed, and applies oil to the surface of the dielectric film 12 to form the insulation pattern. The insulation pattern shows portions to which oil is applied to form portions on the surface of dielectric film 12 where metal is not deposited, such as the slit 14 and the insulation margin 16.

As shown in FIG. 5, the printing roll 40 is formed in a substantially cylindrical shape. A slit forming portion 41 corresponding to the insulation pattern is provided on the outer circumferential surface of the printing roll 40. The slit forming portion 41 corresponds to a “protrusion” of the present disclosure.

As shown in FIG. 6A, the slit forming portion 41 extends in the axial direction of the printing roll 40, and in the present embodiment, a plurality of slit forming portions are arranged at intervals in the circumferential direction of the printing roll 40. Each slit forming portion 41 corresponds to each slit 14 of the metallized film 11. In the present embodiment, the slit forming portions 41 are formed in two rows separated in the axial direction of the printing roll 40. Since the slit forming portions 41 are formed in two rows, two metallized films can be formed at a time. Note that the slit forming portions 41 may be formed in a single row, or may be formed in three or more rows.

The slit forming portion 41 has a shape elongate along the axial direction Ax of the printing roll 40 and the width direction W of the dielectric film 12. Further, the slit forming portion 41 is formed to have a small width to form the slit 14 to have a small slit width d1. Therefore, the reinforcing portion 42 is provided so as not to cause distortion at an end portion of the slit forming portion 41. The reinforcing portion 42 is formed at one end, in the axial direction Ax of the printing roll 40, of the slit forming portion 41. By forming the slit forming portion 41 in such a shape, as shown in FIG. 1A, the cutout 17 is provided at a corner of the divided electrode 13a of the metallized film 11. In other words, the reinforcing portion 42 corresponds to the cutout 17 of the divided electrode 13a.

In the present embodiment, an insulation margin forming portion 43 extending in the circumferential direction is formed on the printing roll 40. The insulation margin forming portion 43 corresponds to the insulation margin 16 of the metallized film 11.

As illustrated in FIG. 6B, when oil 70 is applied to the dielectric film 12 by the printing roll 40, an insulation pattern 14a, an insulation pattern 17a, and an insulation pattern 16a are formed. The insulation pattern 14a is an insulation pattern for forming the slit 14 shown in FIG. 1A. The insulation pattern 17a is an insulation pattern for forming the cutout 17 shown in FIG. 1A. The insulation pattern 16a is an insulation pattern for forming the insulation margin 16 shown in FIG. 1A. As described above, the slit forming portion 41, the reinforcing portion 42, and the insulation margin forming portion 43 are formed in shapes corresponding to the insulation patterns.

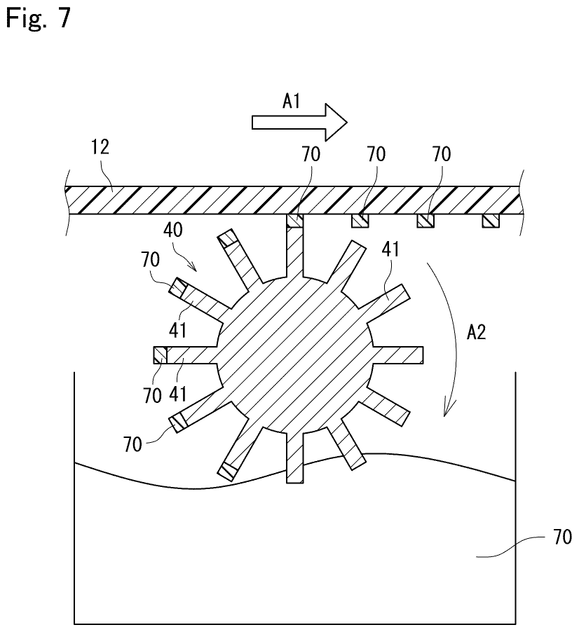

FIG. 7 is a schematic view showing a step of forming an insulation pattern in the metallized film manufacturing device 100 in FIG. 4. The dielectric film 12 is fed in the direction of the arrow A1. During this feeding, the printing roll 40 rotates in the direction of the arrow A2 to feed the oil 70 to a tip of the slit forming portion 41. The oil 70 attaching to the tip of the slit forming portion 41 is transferred to the dielectric film 12, and an insulation pattern is formed on the dielectric film 12. In this step, the oil 70 is also fed to the reinforcing portion 42 of the slit forming portion 41, and the insulation pattern is formed in a shape corresponding to the slit 14. Similarly, oil 70 is also applied to a place corresponding to the insulation margin 16.

The width of the slit forming portion 41 is preferably 0.2 mm or less to correspond to the slit width d1. The slit forming portion 41 is formed to have a width gradually increasing toward one end of the slit forming portion 41. Therefore, one end side of the slit forming portion 41 is formed to have a width increasing toward the outer side. The ratio of the width of the reinforcing portion 42 at its end portion to the width of the slit forming portion 41 is preferably 2 to 42. This corresponds to the ratio of the distance between the adjacent divided electrodes 13a at their end portions to the slit width d1.

In the present embodiment, the slit forming portion 41 has a constant width at the other end.

The printing roll 40 forms the insulation pattern, and then the vapor deposition unit 50 forms the metal vapor deposition electrode 13. In this step, metal is not vapor-deposited on portions where the insulation patterns are formed, and these portions become the slit 14 and the insulation margin 16. Since the slit forming portion 41 is provided with the reinforcing portion 42, the cutout 17 is provided at a corner of the divided electrode 13a of the metal vapor deposition electrode 13 as shown in FIG. 1A.

Since the reinforcing portion 42 is provided at one end of the slit forming portion 41 to reinforce the end portion of the slit forming portion 41, distortion in the end portion of the slit forming portion 41 can be reduced.

The metallized film 11 on which the metal vapor deposition electrode 13 is formed by the vapor deposition unit 50 is wound by the winding unit 60.

### EXAMPLES

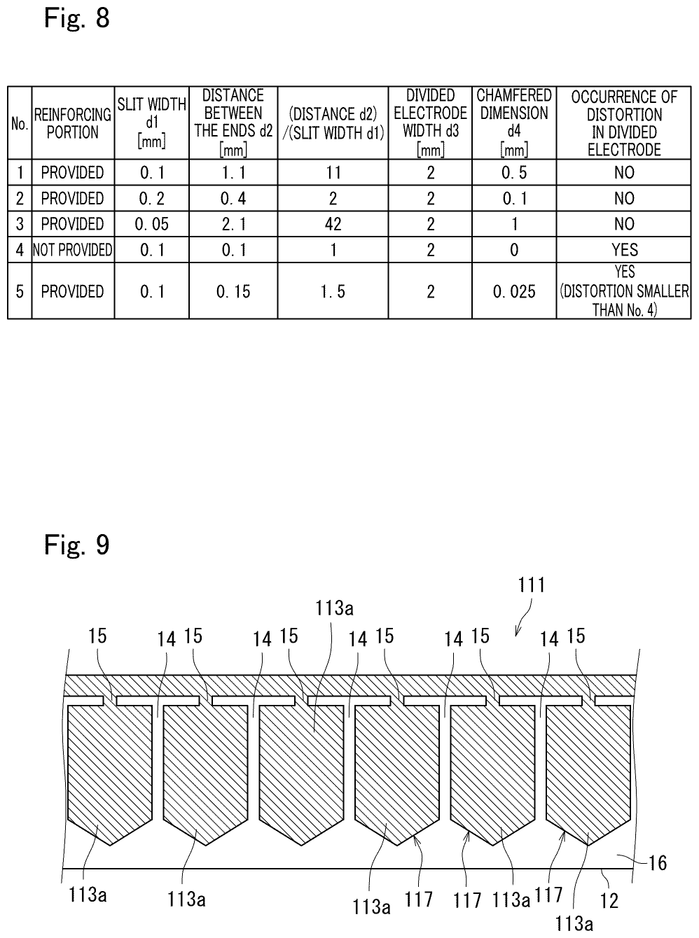

In the metallized film described in the first embodiment, whether distortion occurs in the divided electrode 13a was investigated for variations of the slit width d1. FIG. 8 is a table showing the relationship among the slit width d1, the distance d2 between end portions, on the insulation margin side, of adjacent divided electrodes, and occurrence of distortion in the divided electrodes.

The metallized film 11 of the first embodiment was given a variety of the slit width d1 of 0.1 mm, 0.2 mm, and 0.05 mm while the divided electrode 13a was given a constant electrode width d3 (see FIG. 1A) of 2 mm. Further, the distance d2 (indicated by “end distance d2” in FIG. 8) between the end portions, on the insulation margin 16 side, of the adjacent divided electrodes 13a was varied. The chamfer dimension d4 shown in FIG. 1A was varied to vary the end distance d2. The chamfer dimension d4 represents the size of the cutout 17 in the width direction of the divided electrode 13a (the longitudinal direction L of the dielectric film 12) at an end portion, on the insulation margin 16 side, of the divided electrode 13a.

As shown in FIG. 8, for the slit width d1 of 0.1 mm and the end distance d2 of 1.1 mm, the ratio of the end distance d2 to the slit width d1 was 11. In other words, the ratio of the distance d2 between the end portions, on the insulation margin 16 side, of the adjacent divided electrodes 13a to the slit width d1 was 11. Similarly, for the slit width d1 of 0.2 mm and the end distance d2 of 0.4 mm, the ratio of the end distance d2 to the slit width d1 was 2. For the slit width d1 of 0.05 mm and the end distance d2 of 2.1 mm, the ratio of the end distance d2 to the slit width d1 was 42. For the slit width d1 of 0.1 mm and the end distance d2 of 0.15 mm, the ratio of the end distance d2 to the slit width d1 was 1.5. Note that No. 4 in the table in FIG. 8 is a comparative example having no reinforcing portion, and No. 1 to No. 3 and No. 5 are examples having a reinforcing portion. In the example shown in No. 5, distortion occurred because the reinforcing portion was small, but the magnitude of the distortion was smaller than with no reinforcing portion.

After forming the metal vapor deposition electrodes 13 in the above four patterns, whether distortion occurred in the divided electrode 13a was investigated. As a result, as shown in FIG. 8, no distortion occurred in the divided electrode 13a when the ratio of the end distance d2 to the slit width d1 was 2 to 42. This indicates that no distortion occurred at an end portion of the slit forming portion 41 of the printing roll 40.

Accordingly, it can be understood that the metal vapor deposition electrode 13 was formed as designed using the printing roll 40 when the ratio of the end distance d2 to the slit width d1 was 2 to 42. The metal vapor deposition electrode 13 can be formed as designed. Accordingly, the divided electrode 13a can be stably shaped, and the film capacitor 1 can be formed using the metallized film 11 while suppressing a decrease in capacitance.

### Effects

According to the embodiment described above, the following effects can be obtained.

The metallized film 11 includes the dielectric film 12 and the metal vapor deposition electrode 13. The metal vapor deposition electrode 13 is formed on the surface of the dielectric film 12 with the insulation margin 16 provided at one end in the width direction of the dielectric film 12. The metal vapor deposition electrode 13 includes a plurality of divided electrodes 13a separated by the slits 14 provided along the width direction of the dielectric film 12. Each of a plurality of divided electrodes 13a has the cutout 17 at a corner opposing the insulation margin 16.

With this configuration, the metal vapor deposition electrode 13 divided into a plurality of divided electrodes 13a provides a security function to the film capacitor 1, and at the same time, a decrease in capacitance due to distortion in the divided electrode 13a can be suppressed.

The width d1 of the slit 14 is 0.2 mm or less.

With this configuration, the slit width dl can be reduced to increase the capacitance of the film capacitor 1.

The ratio of the distance between the end portions, on the insulation margin 16 side, of the adjacent divided electrodes 13a to the width dl of the slit 14 is 2 to 42.

With this configuration, distortion in the divided electrode 13a can be suppressed to suppress a decrease in capacitance.

The cutout 17 is formed in a chamfered shape.

With this configuration, distortion in the divided electrode 13a can be suppressed to suppress a decrease in capacitance of the film capacitor 1.

The film capacitor 1 includes the metallized film 11 described above and the end surface electrodes 20. The end surface electrodes 20 are disposed at two ends of the metallized film 11.

With this configuration, the film capacitor 1 in which a decrease in capacitance is suppressed can be provided.

The metallized film manufacturing device 100 includes the feeding unit 30, the printing roll 40, and the vapor deposition unit 50. The feeding unit 30 feeds the dielectric film 12 in the longitudinal direction. The printing roll 40 has a rotation axis in the width direction of the dielectric film 12, and prints an insulation pattern on the surface of the dielectric film 12. The vapor deposition unit 50 forms the metal vapor deposition electrode 13 in a place on the surface of the dielectric film 12 other than where the insulation pattern is printed. The printing roll 40 has the protrusions 41 corresponding to the insulation pattern which is formed on the outer circumferential surface of the printing roll 40 to extend in the axial direction. The reinforcing portion 42 is provided at one end, in the width direction of dielectric film 12, of the protrusion 41.

With this configuration, occurrence of distortion in the protrusion 41 of the printing roll 40 can be suppressed when applying oil to the insulation pattern.

The reinforcing portion 42 has a width gradually increasing toward one end of the protrusion 41.

With this configuration, distortion in the protrusion 41 can be further suppressed.

The width of a portion of the protrusion 41 with no reinforcing portion 42 is 0.2 mm or less.

With this configuration, the width d1 of the slit 14 of the metallized film 11 can be decreased, and thus the capacitance of the film capacitor 1 can be increased.

The ratio of the width of the reinforcing portion 42 at one end of the protrusion 41 to the width of the protrusion 41 is 2 to 42.

With this configuration, distortion in the protrusion 41 can be suppressed with a reduced width of the protrusion 41.

The protrusion 41 has a constant width at the other end in the width direction of the dielectric film 12.

With this configuration, the capacitance of the film capacitor 1 can be increased by increasing the area of the divided electrode 13a as much as possible.

### Exemplary Modification

FIG. 9 is a schematic view showing a metallized film according to a first exemplary modification of the first embodiment. As shown in FIG. 9, in a metallized film 111, a cutout 117 larger than the cutout 17 of the metallized film 11 according to the first exemplary embodiment may be formed to form a divided electrode 113a to have a pointed tip shape.

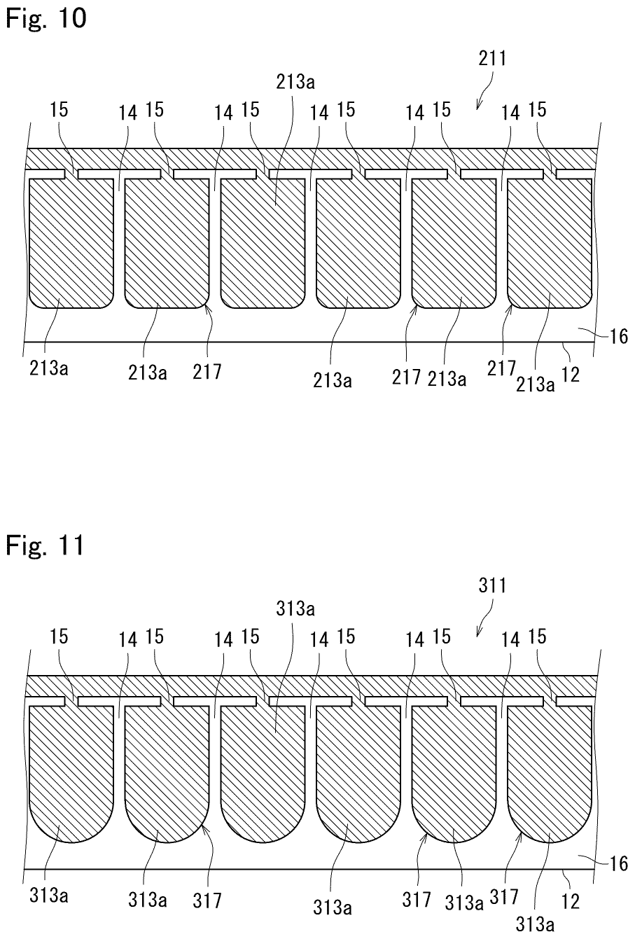

FIG. 10 is a schematic view showing a metallized film according to a second exemplary modification of the first embodiment. As shown in FIG. 10, a metallized film 211 may have a cutout 217 having a rounded shape. Since the cutout 217 has a rounded shape, a divided electrode 213a has a rounded corner, and distortion in the divided electrode 213a can be further suppressed.

FIG. 11 is a schematic view showing a metallized film according to a third exemplary modification of the first embodiment. As shown in FIG. 11, a metallized film 311 may have a cutout 317 having a rounded shape to form the divided electrode 313a with an arc-shaped end.

### Outline of Embodiment

(1) A metallized film manufacturing device including: a feeding unit that feeds a dielectric film in a longitudinal direction; a printing roll that has a rotation axis along a width direction of the dielectric film, and prints an insulation pattern on a surface of the dielectric film, the printing roll has a protrusion extending on an outer circumferential surface of the printing roll in an axial direction of the printing roll and that corresponds to the insulation pattern, and a reinforcing portion is at a first end of the protrusion, the first end being an end in the axial direction of the printing roll; and a vapor deposition unit that forms a metal vapor deposition electrode in a place on a surface of the dielectric film where the insulation pattern is not printed.
(2) In the metallized film manufacturing device according to (1), wherein the reinforcing portion has a width that gradually increases toward the first end of the protrusion in the axial direction.
(3) In the metallized film manufacturing device according to (1) or (2), wherein a width of a portion of the protrusion where the reinforcing portion is not formed is 0.2 mm or less.
(4) In the metallized film manufacturing device according to any one of (1) to (3), wherein a ratio of a width of the reinforcing portion at the first end of the protrusion to a width of the protrusion is 2 to 42.
(5) In the metallized film manufacturing device according to any one of (1) to (4), wherein the protrusion has a constant width at a second end in the width direction of the dielectric film.
(6) A metallized film including a dielectric film and a metal vapor deposition electrode on a surface of the dielectric film with an insulation margin at a first end portion in a width direction of the dielectric film, wherein the metal vapor deposition electrode includes a plurality of divided electrodes separated by a slit extending along the width direction of the dielectric film, and each of the plurality of divided electrodes has a cutout at a corner opposing the insulation margin.
(7) In the metallized film according to (6), wherein a width of the slit is 0.2 mm or less.
(8) In the metallized film according to (6) or (7), wherein a ratio of a distance between end portions of adjacent divided electrodes of the plurality of divided electrodes to the width of the slit is 2 to 42, the end portions being on a same side as the insulation margin.
(9) In the metallized film according to any one of (6) to (8), wherein the cutout has a chamfered shape.
(10) In the metallized film according to any one of (6) to (8), wherein the cutout has a rounded shape.
(11) A film capacitor including the metallized film according to any one of (6) to (10) and a pair of end surface electrodes disposed at opposed ends of the metalized film.

The present disclosure can be widely applied to a metallized film for forming a film capacitor and a manufacturing device for the metallized film.

### REFERENCE SIGNS LIST

1 film capacitor
10 wound body
11, 111, 211, 311 metallized film
12 dielectric film
13 metal vapor deposition electrode
13a, 113a, 213a, 313a divided electrode
13b connecting portion
14 slit
15 fuse
16 insulation margin
20 end surface electrode
30 feeding unit
40 printing roll
41 slit forming portion (protrusion)
42 reinforcing portion
50 vapor deposition unit
100 manufacturing device
d1 slit width
d2 end distance
L longitudinal direction
W width direction

1. A metallized film manufacturing device comprising:
a feeding unit that feeds a dielectric film in a longitudinal direction;
a printing roll that has a rotation axis along a width direction of the dielectric film, and prints an insulation pattern on a surface of the dielectric film, the printing roll has a protrusion extending on an outer circumferential surface of the printing roll in an axial direction of the printing roll and that corresponds to the insulation pattern, and a reinforcing portion is at a first end of the protrusion, the first end being an end in the axial direction of the printing roll; and
a vapor deposition unit that forms a metal vapor deposition electrode in a place on a surface of the dielectric film where the insulation pattern is not printed.

2. The metallized film manufacturing device according to claim 1, wherein the reinforcing portion has a width that increases toward the first end of the protrusion in the axial direction.

3. The metallized film manufacturing device according to claim 1, wherein a width of a portion of the protrusion where the reinforcing portion is not formed is 0.2 mm or less.

4. The metallized film manufacturing device according to claim 1, wherein a ratio of a width of the reinforcing portion at the first end of the protrusion to a width of the protrusion is 2 to 42.

5. The metallized film manufacturing device according to claim 1, wherein the protrusion has a constant width at a second end in the width direction of the dielectric film.

6. A metallized film comprising:
a dielectric film; and
a metal vapor deposition electrode on a surface of the dielectric film with an insulation margin at a first end portion in a width direction of the dielectric film, wherein the metal vapor deposition electrode includes a plurality of divided electrodes separated by a slit extending along the width direction of the dielectric film, and each of the plurality of divided electrodes has a cutout at a corner opposing the insulation margin.

7. The metallized film according to claim 6, wherein a width of the slit is 0.2 mm or less.

8. The metallized film according to claim 7, wherein a ratio of a distance between end portions of adjacent divided electrodes of the plurality of divided electrodes to the width of the slit is 2 to 42, the end portions being on a same side as the insulation margin.

9. The metallized film according to claim 6, wherein a ratio of a distance between end portions of adjacent divided electrodes of the plurality of divided electrodes to a width of the slit is 2 to 42, the end portions being on a same side as the insulation margin.

10. The metallized film according to claim 6, wherein the cutout has a chamfered shape.

11. The metallized film according to claim 6, wherein the cutout has a rounded shape.

12. The metallized film according to claim 6, wherein the metal vapor deposition electrode includes a connecting portion extending along a longitudinal direction of the dielectric film at a second end portion in the width direction of the dielectric film.

13. The metallized film according to claim 12, wherein each of the plurality of divided electrodes is connected to the connecting portion via a fuse.

14. A film capacitor comprising:
the metallized film according to claim 6; and
a pair of end surface electrodes disposed at opposed ends of the metallized film.

15. The film capacitor according to claim 14, wherein a width of the slit is 0.2 mm or less.

16. The film capacitor according to claim 14, wherein a ratio of a distance between end portions of adjacent divided electrodes of the plurality of divided electrodes to a width of the slit is 2 to 42, the end portions being on a same side as the insulation margin.

17. The film capacitor according to claim 14, wherein the cutout has a chamfered shape.

18. The film capacitor according to claim 14, wherein the cutout has a rounded shape.

19. The film capacitor according to claim 14, wherein the metal vapor deposition electrode includes a connecting portion extending along a longitudinal direction of the dielectric film at a second end portion in the width direction of the dielectric film.

20. The film capacitor according to claim 19, wherein each of the plurality of divided electrodes is connected to the connecting portion via a fuse.
